(19) United States
(12) Patent Application Publication
(10) Pub. No.: US 2024/0025232 A1
(43) Pub. Date: Jan. 25, 2024

(54) KINETIC POWER CONVERTER FOR OCCUPANT HEATING OF VEHICLE

(71) Applicant: GM GLOBAL TECHNOLOGY OPERATIONS LLC, Detroit, MI (US)

(72) Inventor: George Samuel Watson, II, Southfield, MI (US)

(21) Appl. No.: 17/872,243

(22) Filed: Jul. 25, 2022

(51) Int. Cl. B60H 1/22; F24V 40/00; B60H 1/00

(52) U.S. Cl. CPC B60H 1/22; F24V 40/00; B60H 1/0045; B60H 1/00764; B60H 1/00735; B60H 2001/2271; B60H 2001/2278; B60H 2001/224

(57) ABSTRACT

A passenger cabin heating system of a vehicle includes: a passenger cabin heat exchanger configured to transfer heat from a fluid within the passenger cabin heat exchanger to air passing the passenger cabin heat exchanger; a blower configured to blow air past the passenger cabin heat exchanger and into a passenger cabin of the vehicle; a housing; the fluid within the housing; and a propeller disposed within the housing and surrounded by the fluid and configured to rotate with a wheel of the vehicle, thereby warming the fluid within the housing.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle heating and more particularly to systems and methods for heating a passenger cabin of a vehicle.

Some types of vehicles include only an internal combustion engine that generates propulsion torque. Hybrid vehicles include both an internal combustion engine and one or more electric motors. Some types of hybrid vehicles utilize the electric motor and the internal combustion engine to improve fuel efficiency. Other types of hybrid vehicles utilize the electric motor and the internal combustion engine to achieve greater torque output.

Examples of hybrid vehicles include parallel hybrid vehicles, series hybrid vehicles, and other types of hybrid vehicles. In a parallel hybrid vehicle, the electric motor works in parallel with the engine to combine power and range advantages of the engine with efficiency and regenerative braking advantages of electric motors. In a series hybrid vehicle, the engine drives a generator to produce electricity for the electric motor, and the electric motor drives a transmission. This allows the electric motor to assume some of the power responsibilities of the engine, which may permit the use of a smaller and possibly more efficient engine. The present application is applicable to electric vehicles, hybrid vehicles, and other types of vehicles.

### SUMMARY

In a feature, a passenger cabin heating system of a vehicle includes: a passenger cabin heat exchanger configured to transfer heat from a fluid within the passenger cabin heat exchanger to air passing the passenger cabin heat exchanger; a blower configured to blow air past the passenger cabin heat exchanger and into a passenger cabin of the vehicle; a housing; the fluid within the housing; and a propeller disposed within the housing and surrounded by the fluid and configured to rotate with a wheel of the vehicle, thereby warming the fluid within the housing.

In further features, a pump is configured to pump the fluid from the housing to the passenger cabin heat exchanger.

In further features, a pump is configured to pump the fluid from the passenger cabin heat exchanger to the housing.

In further features, the propeller is configured to: propel the fluid out of the housing and to the passenger cabin heat exchanger; and draw the fluid out of the passenger cabin heat exchanger and to the housing.

In further features: a first shaft is configured to drive rotation of the propeller; a second shaft is configured to rotate with the wheel; and a clutch is configured to couple and decouple the second shaft to and from the first shaft.

In further features, a control module is configured to actuate the clutch based on a vehicle speed.

In further features, the control module is configured to selectively actuate the clutch and couple the first shaft to the second shaft when the vehicle speed is greater than a predetermined speed.

In further features, the control module is configured to actuate the clutch and decouple the first shaft from the second shaft when the vehicle speed is less than the predetermined speed.

In further features, a control module is configured to actuate the clutch based on a temperature of air within the passenger cabin.

In further features, the control module is configured to selectively actuate the clutch and couple the first shaft to the second shaft when the temperature is less than a predetermined temperature.

In further features, the control module is configured to actuate the clutch and decouple the first shaft from the second shaft when the temperature is greater than the predetermined temperature.

In a feature, a passenger cabin heating method for a vehicle includes: by a blower, blowing air past a passenger cabin heat exchanger and into a passenger cabin of the vehicle, the passenger cabin heat exchanger configured to transfer heat from a fluid within the passenger cabin heat exchanger to air passing the passenger cabin heat exchanger; and by a propeller disposed within a housing and surrounded by fluid, rotating within the housing thereby warming the fluid within the housing.

In further features, the passenger cabin heating method further includes pumping the fluid from the housing to the passenger cabin heat exchanger.

In further features, the passenger cabin heating method further includes pumping the fluid from the passenger cabin heat exchanger to the housing.

In further features, the passenger cabin heating method further includes, by the propeller: propelling the fluid out of the housing and to the passenger cabin heat exchanger; and drawing the fluid out of the passenger cabin heat exchanger and to the housing.

In further features, the passenger cabin heating method further includes: by a clutch, selectively coupling and decoupling a second shaft to and from a first shaft, the first shaft configured to drive rotation of the propeller, and the second shaft configured to rotate with a wheel.

In further features, the passenger cabin heating method further includes actuating the clutch based on a vehicle speed.

In further features, the passenger cabin heating method further includes selectively actuating the clutch and coupling the first shaft to the second shaft when the vehicle speed is greater than a predetermined speed.

In further features, the passenger cabin heating method further includes actuating the clutch and decoupling the first shaft from the second shaft when the vehicle speed is less than the predetermined speed.

In further features, the passenger cabin heating method further includes actuating the clutch based on a temperature of air within the passenger cabin.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle;

FIGS. 2-3 are functional block diagrams of example passenger cabin heating systems of a vehicle; and

FIG. 4 is a flowchart depicting an example method of controlling a clutch and heating within the passenger cabin.

In the drawings, reference numbers may be reused to identify similar and/or identical elements.

### DETAILED DESCRIPTION

Combustion within an internal combustion engine generates heat. A coolant is used to cool the engine via circulating the warm coolant from the engine through a radiator (a heat exchanger) where heat from the coolant is transferred to air passing the radiator. Warm coolant can also be circulated to a passenger cabin heat exchanger for warming of a passenger cabin of a vehicle.

Pure electric vehicles, however, do not include an internal combustion that generates heat. Thus, coolant warmed by an internal combustion engine cannot be used for warming of the passenger cabin. For pure electric vehicles, an electric heater can be used to heat a fluid that can be circulated through the passenger cabin heat exchanger for warming of the passenger cabin. Use of an electric heater, however, consumes power and may decrease a range of a pure electric vehicle.

The present application involves use of a kinetic device that is driven by one or more wheels of the vehicle. The kinetic device converts kinetic energy from the wheel(s) into heat energy and warms the fluid that is circulated through the passenger cabin heat exchanger to warm the passenger cabin. Use of the kinetic device is more efficient than use of an electric heater and warming the fluid in other manners.

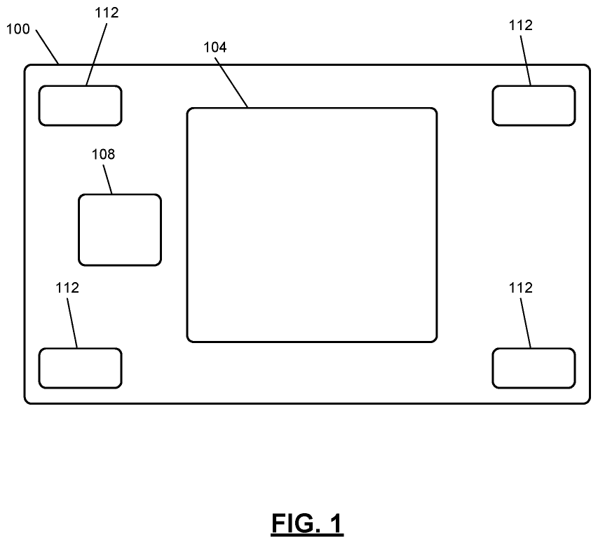

FIG. 1 is a functional block diagram of an example vehicle 100. Passengers of the vehicle 100 ride within a passenger cabin 104. One or more seats for vehicle occupants are disposed within the passenger cabin 104.

The vehicle 100 includes one or more propulsion devices 108 that output torque for propulsion of the vehicle 100. Examples of propulsion devices include electric motors, combustion engines, and other types of propulsion devices. The vehicle 100 may be a purely electric vehicle including one or more electric motors and not including any combustion engines, a hybrid vehicle including at least one electric motor and at least one combustion engine, a non-hybrid vehicle including one or more combustion engines and not including any electric motors, or another suitable type of vehicle.

The vehicle 100 includes wheels 112. While the example of four wheels is shown, the vehicle 100 may have a greater or fewer number of wheels. The propulsion device(s) 108 output torque to one or more of the wheels 112 to propel the vehicle 100.

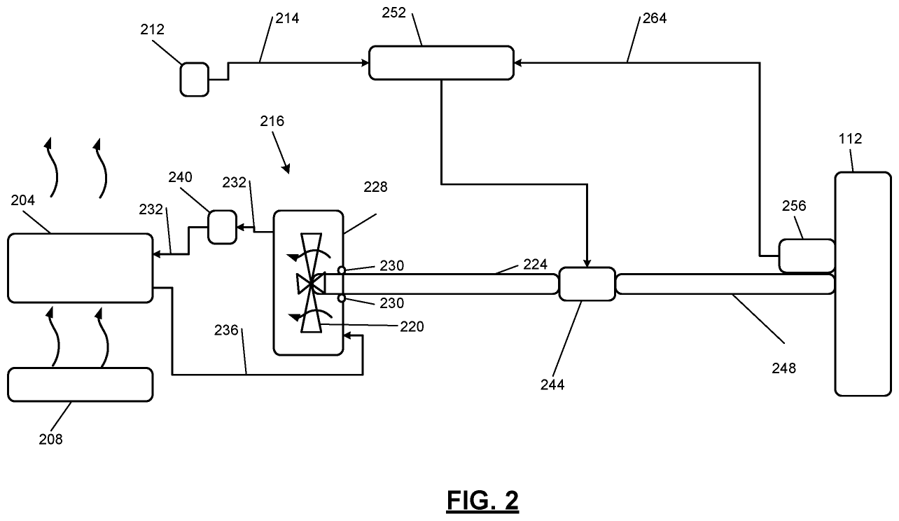

FIG. 2 includes a functional block diagram of an example passenger cabin heating system of the vehicle 100. A passenger cabin heat exchanger 204 is used to warm air within the passenger cabin 104. More specifically, the passenger cabin heat exchanger 204 transfers heat from a warm fluid flowing through the passenger cabin heat exchanger 204 to air passing the passenger cabin heat exchanger 204. The fluid may be a coolant, an oil, water, or another suitable type of fluid.

A blower 208 blows air past the passenger cabin heat exchanger 204 and into the passenger cabin 104. The blower 208 may draw in air from within the passenger cabin 104. Air may flow from the passenger cabin heat exchanger 204 through ducts and to the passenger cabin 104. A cabin temperature sensor (T) 212 measures a temperature 214 of the air within the passenger cabin 104.

A kinetic device 216 converts kinetic energy into heat and heats (warms) the fluid that can be flowed to or flow to the passenger cabin heat exchanger 204. The kinetic device 216 includes a propeller or a turbine 220. Rotation of a first shaft 224 drives rotation of the propeller 220. The propeller 220 is disposed within a housing 228. The fluid fills the housing 228. An aperture extends through the housing 228 through which the first shaft 224 extends may be fluidly sealed, such as by an O-ring 230 or a gasket.

As stated above, rotation of the propeller 220 converts kinetic energy into heat energy. The generation of heat from rotation can be described by

½*l*w²=cp*mf*Δh,

where l is the moment of inertia, w is the angular velocity of the propeller 220, cp is the specific heat of the fluid, mf is the mass flowrate of the fluid, and h is the enthalpy of the fluid.

Warmed fluid flows from the kinetic device 216 (the housing) to the passenger cabin heat exchanger 204 via one or more tubes 232. After flowing through the passenger cabin heat exchanger 204, (cooler) fluid flows back to the kinetic device 216 (the housing) via one or more tubes 236.

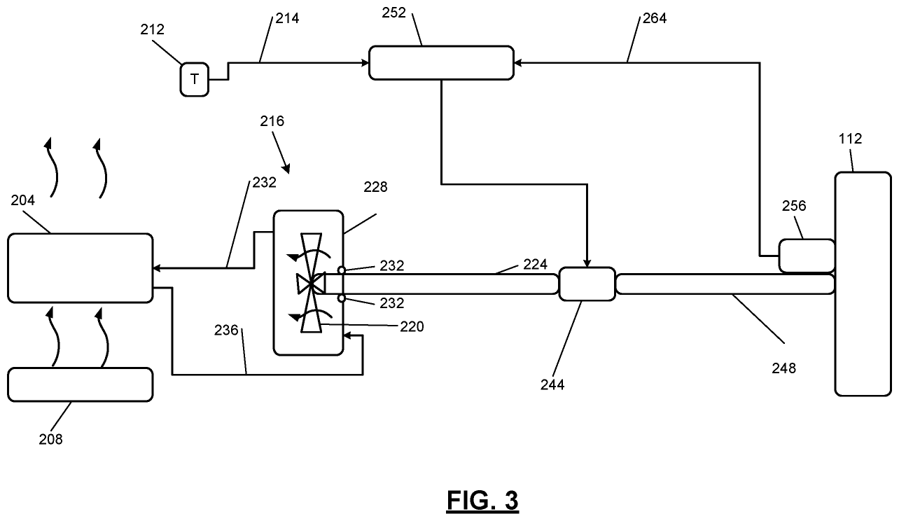

As illustrated in FIG. 2, a pump (P) 240 may pump the fluid from the kinetic device 216 to the passenger cabin heat exchanger 204. In various implementations, the pump 240 may be located in the tube(s) 236 and pump the fluid from the passenger cabin heat exchanger 204 to the kinetic device 216. As illustrated in FIG. 3, the pump 240 may be omitted. The propeller 220 propels the fluid from a first direction to a second direction during rotation, such as illustrated. With the tube(s) 232 being connected in the second direction, the propeller 220 propels the warmed fluid to the passenger cabin heat exchanger 204. With the tube(s) 236 being connected in the first direction, the propeller 220 draws the fluid from the passenger cabin heat exchanger 204.

When a clutch 244 is engaged, a second shaft 248 drives rotation of the first shaft 224. Rotation of a wheel 112 of the vehicle drives rotation of the second shaft 248. The wheel 112 may be a driven wheel and may be driven by one or more propulsion devices or a non-driven wheel and not driven by any propulsion devices. When the clutch 244 is disengaged, the first shaft 224 is disconnected from the second shaft 248 such that rotation of the second shaft 248 does not cause rotation of the first shaft 224. A control module 252 controls engagement and disengagement of the clutch 244 to control heating within the passenger cabin using the fluid warmed by the kinetic device 216.

A wheel speed sensor 256 may measure a rotational speed 264 of the wheel 112. A vehicle speed module (e.g., of the control module 252) determines a speed of the vehicle (a vehicle speed) based on the rotational speed 264 of the wheel 112 and one or more characteristics of the wheel(s) (e.g., circumference, radius, diameter). The vehicle speed module may determine the speed of the vehicle based on the rotational speed 264 of one or more of the other wheels 112, such as based on an average of the rotational speeds of two or more of the wheels 112.

The control module 252 controls the engagement and disengagement of the clutch 244 based on the temperature 214 within the passenger cabin 104 and the vehicle speed. The control module 252 may, for example, engage the clutch 244 (to convert kinetic energy into heat energy) when the vehicle speed is greater than a predetermined speed and the temperature 214 is less than a temperature setpoint for within the passenger cabin 104. The predetermined speed may be calibratable and may be, for example, 45 miles per hour, 40 miles per hour, 35 miles per hour, 30 miles per hour, 25 miles per hour, or another suitable speed greater than or equal to miles per hour. The temperature setpoint may be variable and set in response to user input within the passenger cabin 104. The user input may be received, for example, via one or more buttons, switches, a touchscreen display, or other suitable input device. The control module 252 may disengage the clutch 244 when at least one of (a) the vehicle speed is less than the predetermined speed and (b) the temperature 214 is greater than the temperature setpoint for within the passenger cabin 104.

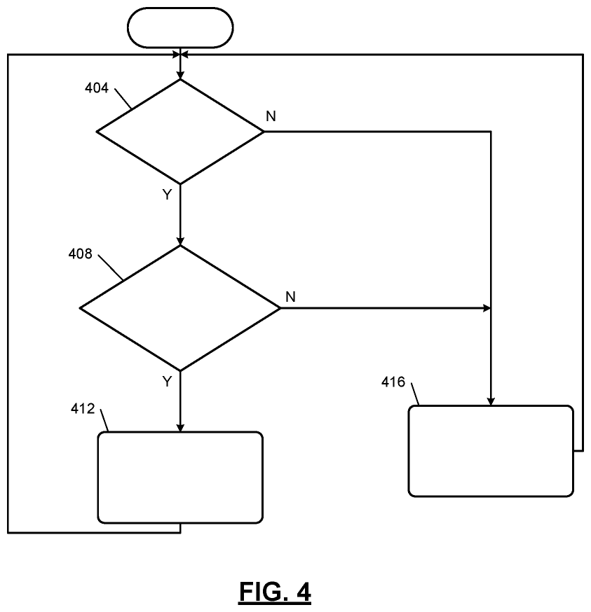

FIG. 4 is a flowchart depicting an example method of controlling the clutch 244 and heating within the passenger cabin 104. Control begins with 404 where the control module 252 determines whether the vehicle speed is greater than the predetermined speed. If 404 is true, control continues with 408. If 404 is false, at 416 the control module 252 disengages the clutch 244 such that warming of the fluid by the kinetic device 216 is not performed. If the pump 240 is implemented, the control module 252 also disables (turns OFF) the pump 240 at 416.

At 408, the control module 252 determines whether the temperature 214 is greater than the temperature setpoint. If 408 is true, control continues with 412. If 408 is false, control transfers to 416. At 412, the control module 252 engages the clutch 244. Rotation of the wheel therefore drives rotation of the propeller 220 and kinetic energy is converted into heat energy in the fluid. The fluid warms air flowing to the passenger cabin 104 within the passenger cabin heat exchanger 204. The fluid flows to the passenger cabin heat exchanger 204 via the propeller 220 or is pumped to the passenger cabin heat exchanger 204 by the pump 240. If the pump 240 is implemented, the control module 252 also enables (turns ON) the pump 240.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A passenger cabin heating system of a vehicle, comprising:
a passenger cabin heat exchanger configured to transfer heat from a fluid within the passenger cabin heat exchanger to air passing the passenger cabin heat exchanger;
a blower configured to blow air past the passenger cabin heat exchanger and into a passenger cabin of the vehicle;
a housing;
the fluid within the housing; and
a propeller disposed within the housing and surrounded by the fluid and configured to rotate with a wheel of the vehicle, thereby warming the fluid within the housing.

2. The passenger cabin heating system of claim 1 further comprising a pump configured to pump the fluid from the housing to the passenger cabin heat exchanger.

3. The passenger cabin heating system of claim 1 further comprising a pump configured to pump the fluid from the passenger cabin heat exchanger to the housing.

4. The passenger cabin heating system of claim 1 wherein the propeller is configured to:
propel the fluid out of the housing and to the passenger cabin heat exchanger; and
draw the fluid out of the passenger cabin heat exchanger and to the housing.

5. The passenger cabin heating system of claim 1 further comprising:
a first shaft configured to drive rotation of the propeller;
a second shaft configured to rotate with the wheel; and
a clutch configured to couple and decouple the second shaft to and from the first shaft.

6. The passenger cabin heating system of claim 5 further comprising a control module configured to actuate the clutch based on a vehicle speed.

7. The passenger cabin heating system of claim 6 wherein the control module is configured to selectively actuate the clutch and couple the first shaft to the second shaft when the vehicle speed is greater than a predetermined speed.

8. The passenger cabin heating system of claim 7 wherein the control module is configured to actuate the clutch and decouple the first shaft from the second shaft when the vehicle speed is less than the predetermined speed.

9. The passenger cabin heating system of claim 5 further comprising a control module configured to actuate the clutch based on a temperature of air within the passenger cabin.

10. The passenger cabin heating system of claim 9 wherein the control module is configured to selectively actuate the clutch and couple the first shaft to the second shaft when the temperature is less than a predetermined temperature.

11. The passenger cabin heating system of claim 10 wherein the control module is configured to actuate the clutch and decouple the first shaft from the second shaft when the temperature is greater than the predetermined temperature.

12. A passenger cabin heating method for a vehicle, comprising:
by a blower, blowing air past a passenger cabin heat exchanger and into a passenger cabin of the vehicle, the passenger cabin heat exchanger configured to transfer heat from a fluid within the passenger cabin heat exchanger to air passing the passenger cabin heat exchanger; and
by a propeller disposed within a housing and surrounded by fluid, rotating within the housing thereby warming the fluid within the housing.

13. The passenger cabin heating method of claim 12 further comprising pumping the fluid from the housing to the passenger cabin heat exchanger.

14. The passenger cabin heating method of claim 12 further comprising pumping the fluid from the passenger cabin heat exchanger to the housing.

15. The passenger cabin heating method of claim 12 further comprising, by the propeller:
propelling the fluid out of the housing and to the passenger cabin heat exchanger; and
drawing the fluid out of the passenger cabin heat exchanger and to the housing.

16. The passenger cabin heating method of claim 12 further comprising:
by a clutch, selectively coupling and decoupling a second shaft to and from a first shaft, the first shaft configured to drive rotation of the propeller, and the second shaft configured to rotate with a wheel.

17. The passenger cabin heating method of claim 16 further comprising actuating the clutch based on a vehicle speed.

18. The passenger cabin heating method of claim 17 further comprising selectively actuating the clutch and coupling the first shaft to the second shaft when the vehicle speed is greater than a predetermined speed.

19. The passenger cabin heating method of claim 18 further comprising actuating the clutch and decoupling the first shaft from the second shaft when the vehicle speed is less than the predetermined speed.

20. The passenger cabin heating method of claim 16 further comprising actuating the clutch based on a temperature of air within the passenger cabin.
